(19) United States
(12) Patent Application Publication
(10) Pub. No.: US 2016/0312759 A1
(43) Pub. Date: Oct. 27, 2016

(54) DEVICE FOR GENERATING ENERGY ON THE BASIS OF WAVE MOTION

(71) Applicant: Ardavan Shafiie, Heerlen (NL)

(72) Inventor: Ardavan SHAFIIE, HEERLEN (NL)

(21) Appl. No.: 15/101,462

(22) PCT Filed: Dec. 3, 2013
(86) PCT No.: PCT/NL2013/000060

§ 371 Date: Jun. 3, 2016

(30) Foreign Application Priority Data
Dec. 10, 2012 (NL) 2009951

(51) Int. Cl. F03B 13/20; F03D 9/00; F03B 13/10

(52) U.S. Cl. CPC F03B 13/20; F03B 13/10; F03D 9/008; F05B 2260/40311; F05B 2240/60

(57) ABSTRACT

A device (1) for generating energy on the basis of wave motion comprises a rotatably arranged basic body (10); an elongated, rod-shaped body (20) which is connected to the basic body (10), and which has buoyancy with respect to sea water; an arm (30) which extends between the basic body (10) and the rod-shaped body (20) and interconnects these two bodies (10, 20); and a main shaft (40) which is connected to the basic body (10) for the purpose of being driven by the basic body (10). The rod-shaped body (20) is destined to be moved in and out of the water under the influence of wave motion, and of a rotary movement of the basic body (10), which performs a flywheel function during operation of the device (1). Due to this, the said rotary movement can be maintained.

The invention relates to a device for generating energy on the basis of wave motion.

Various devices for generating energy on the basis of wave motion are known in practice. An important cause of the arising of wave motion in a large mass of water such as a sea or an ocean is the impact of wind on the water surface. Under the influence of the wind, the water is put in motion, and is thereby capable of exerting forces on bodies which are present in the water, especially pushing forces. That fact can be used for generating energy, as movement of a body is energy which can be introduced in a device, and which, if so desired, can be transformed to another form of energy, for example, electricity.

For the sake of completeness, it is noted that for clarity reasons, the term “sea” will hereinafter be used as an overall term for large masses of water in which waves may arise, particularly seas and oceans.

It is an object of the invention to provide a device which is intended to be arranged at sea, and which is capable of generating energy on the basis of wave motion in an efficient and secure manner. This object is achieved by means of a device which comprises the following components: a rotatably arranged basic body; an elongated, rod-shaped body which is connected to the basic body, which has buoyancy with respect to sea water, and which is destined to be moved in and out of the water under the influence of wave motion, and of a rotary movement of the basic body; an arm which extends between the basic body and the rod-shaped body, and which connects these two bodies with each other; and a main shaft which is connected to the basic body in order to be driven by the basic body.

In the device according to the invention, the rod-shaped body is the aforementioned body which can be put in motion under the influence of wave motion. The rod-shaped body extends at one side of a rotatably arranged basic body, while a main shaft is connected to the basic body as well, and, in practical embodiments of the device, extends at the other side of the basic body. When the rod-shaped body moves in a way which will be further explained in the following, a rotation of the basic body is obtained as a result thereof, wherein the main shaft is put in rotation as well. Once the basic body and the main shaft are rotating, kinetic energy is present in the device, which can partly contribute to the rotary movement being guaranteed. Preferably, the rod-shaped body is significantly longer than a possible height of the waves. In that case, if a counteracting wave acts on the rod-shaped body, if such wave is present at all, only a first position of the rod-shaped body is impacted, especially a portion which is present at the side of the basic body. The primary function of the basic body is the function of a transformer of movement of the rod-shaped body as caused by wave motion to the main shaft. Also, the basic body functions as a flywheel. Irregularities in the movement of the rod-shaped body are dampened, as it were, as a result of the inertia of the basic body. In the process, a module having a mass which is slidably arranged along the basic body can be used, as will be explained later in this description.

In the following description of the movement of the rod-shaped body which leads to a rotation of the basic body, the fact that successive waves are capable of exerting a pushing force on the rod-shaped body in a regular, periodical manner is taken as a basic assumption. Also, it is assumed that the rod-shaped body is oriented with respect to the waves in such a way that a longitudinal axis of the aforementioned body extends substantially perpendicular with respect to the waves. In this respect, it is noted that it is advantageous when the device is arranged close to the coast. In view of the fact that close to the coast, the waves are parallel to the coastline, it is advantageous when the longitudinal axis of the rod-shaped body is oriented perpendicular with respect to the coastline. Furthermore, it is advantageous when the device is provided with means to detect the wave force, and, for example, also with means with which a measurement of the wind direction can be performed in any known manner. Besides, it can be advantageous if the device is displaceable in a vertical direction, so that it is possible to adapt the position of the device to the water level. Another possibility for adaptation is an orientation of the rotation axis of the basic body. The rotation axis does not necessarily need to extend parallel to the sea level. It is possible to force the basic body to tilt in order to orient the rotation axis at an angle with the sea level, wherein the longitudinal axis of the rod-shaped body is oriented at an angle with the sea level as well.

Furthermore, the following description relates to a preferred embodiment of the device according to the invention in which:
the rod-shaped body extends at a position which, as projected on the basic body in the direction of a rotation axis of the basic body, is eccentric with respect to the rotation axis of the basic body, wherein the rod-shaped body can exert a larger momentum on the basic body than as would be the case in respect of a position of the rod-shaped body in which a longitudinal axis of the rod-shaped body would coincide with the rotation axis of the basic body;
the arm is connected to the basic body at a position which is eccentric with respect to the rotation axis of the basic body, wherein the arm is connected to the rod-shaped body at a position which is at a distance of the basic body, which is also advantageous in respect of the magnitude of the momentum which is exerted on the basic body;
means are provided to allow for rotation of the basic body in one direction and to block such rotation in the other direction; and
a rotation axis of the main shaft substantially coincides with a rotation axis of the basic body.

Depending on the angular position of the basic body, the rod-shaped body has a higher or a lower position with respect to a level at which the rotation axes of the basic body and the main shaft connected therewith are located. A highest position is taken as an initial position of the movement of the rod-shaped body. In this position, the rod-shaped body extends above the average water level, and will sag under the influence of its own weight, whereby an inclination of the said body is obtained. The fact that the rod-shaped body is connected to the basic body through an arm further contributes to the inclination. The connection is of such nature that an extra momentum can be obtained in the movement of the rod-shaped body. Besides, the rod-shaped body and the arm can be formed as one integral entirety.

Under the influence of gravity, the rod-shaped body will move from the highest position to a lower position. During this movement, the rod-shaped body submerges in the water, to an increasing extent, and will experience an increasing pushing action of the water as a result thereof. This pushing action is obtained on the basis of wave motion, and also on the basis of the lifting force which is the result of the displacement of water caused by the rod-shaped body, whereby the rod-shaped body involves less weight. As long as the rod-shaped body is still outside of the water, a relatively large momentum is exerted by this body. When the rod-shaped body is in the water, the lifting force and the energy as stored in the basic body in the foregoing process cause improvement of the rotary movement of the basic body. The means which are provided to allow for rotation of the basic body in one direction and to block such rotation in the other direction have an important function in guaranteeing the rotary movement of the basic body. As soon as the rod-shaped body is at a lowest level, the pushing action has a supporting function with the movement of the rod-shaped body, combined with the inclination of the basic body to rotate further and pull the rod-shaped body to a higher position again in doing so. Assuming that the said two factors represent sufficient force to act against gravity, the rod-shaped body eventually ends up at the highest position again and starts with a next rotary movement.

By means of a handy combination of a rod-shaped body and a basic body with a certain mass in order to perform a function as flywheel in the device, wherein said bodies are connected to each other through an arm, which may be embodied as a rod formed according to a part of a helix, for example, it is possible to realise a rotation of the basic body under the influence of gravity, wave motion and lifting force. The application of the means for allowing for rotation of the basic body in one direction and block such rotation in the other direction contributes to realising a continuous rotation of the basic body. Also, in that case, it is guaranteed that the rotation is always in the right direction in order to have the aforementioned extra momentum of the arm.

In the design of the device according to the invention, a rotation of the basic body directly brings about a rotation of the main shaft. Numerous manners of taking energy from a rotating shaft and transforming such energy are known. It is possible to use a gear box, wherein the main shaft is connected to one of the gears of the gear box. Preferably, measures are taken to minimise losses such as friction losses in the gear box, so that a high as possible output of the device can be obtained. Furthermore, in a usual manner, the device can be provided with means for bearing the main shaft on at least one position between the basic body and the gear box. In this respect, it is also true that it is advantageous when losses are minimised. Generally, for optimal output, the concept of minimising losses on every position in the device is very important.

As has been said before, the basic body is capable of performing a function as flywheel. The energy from the water provides for the net energy supply to the system, wherein the basic body has a function in the correct dosing of the energy at the correct moment in the movement of the rod-shaped body. For starting the device, and letting the device run in an optimal manner, it is preferred when a motor for driving the main shaft is provided. That would be an additional motor in that case, which is only addressed for starting purposes.

In order to have further support of the aforementioned rotary movement and additional supply of energy to the device, the device can be equipped with a windmill and means for translating a rotation of an output shaft of the windmill to the main shaft. In a manner known per se, means can be provided for adjusting a position of the windmill, particularly of a rotor of the windmill, to the actual direction of the wind in an optimal manner. Furthermore, the wind energy can be applied for allowing for a continuation of the rotary movement even in a case of a very irregular wave pattern.

Another type of support of the rotary movement includes the application of a module having a mass which is slidably arranged along the basic body, and means for driving the mass, which may comprise a toothed bar and a toothed gear for translating the toothed bar, for example, wherein a coupling between the toothed gear and the basic body is provided, and wherein the mass is located on the toothed bar. The mass as mentioned can support the flywheel function of the basic body by automatically exerting an extra momentum when the toothed bar is displaced outwardly. When, at a certain moment, the wave motion supplies an insufficient amount of energy for letting the rod-shaped body move from a lower to a higher position, the rotary movement of the basic body can still be continued due to the inertia thereof and the extra momentum which is caused by the mass. In this way, the application of the module having the slidably arranged mass also contributes to continuity and stability of the rotary movement. Energy which is already present in the device is applied in an advantageous manner in order to realise the rotary movement in an optimal manner.

It is noted that US 2009/108584 A1 shows a wave turbine, which is adapted to harvest both potential and kinetic energy from wave motion using turbine elements such as blades, scoops or buckets which are applied in pairs. Each of the said pairs of turbine elements is connected to a central shaft, wherein the turbine elements of a pair are connected to a periphery of the central shaft through an arm at opposite positions. The pairs are arranged one behind the other, wherein the pairs have a mutual angular displacement of 90°. The wave turbine is arranged with respect to the waves in such a way that only turbine elements having a lowest “6 o'clock position” can have an interaction with the waves. In that way, it can be achieved that when a wave flows past, this wave can put a lowest turbine element of a first pair from the “6 o'clock position” to a “9 o'clock position”, as a result of which the central shaft rotates, and as a result of which a turbine element of a second pair moves from a “3 o'clock position” to the “6 o'clock position”. As the wave moves on, the lowest turbine element of the second pair is moved from the “6 o'clock position” to a higher position by another part of the wave, as a result of which a turbine element of a third pair ends up at the “6 o'clock position” for interaction with a wave. This process is repeated along the central shaft, as a result of which said shaft starts rotating.

An important difference between the device according to the invention and the known wave turbine is that it is not possible to find in the wave turbine something like a rotatably arranged basic body which has a function in moving a rod-shaped body in and out of the water. In other words, it is not possible to find a component of the wave turbine which is adapted to perform a function as flywheel. Instead, the wave turbine has a complex construction with a plurality of pairs of turbine elements, wherein the impact of a wave on successive pairs needs to realise a rotary movement of a central shaft which is present for interconnecting the pairs.

US 2010/140944 A1 shows a wave energy converter which is provided with a float and a reactive body which is hingably suspended from the float, and which extends from the float in the water as a result thereof. Under the influence of waves, the float moves up and down, while the reactive body performs a pitching movement in the water. Energy is taken from a hinge between the float and the reactive body, about which the float and the reactive body perform a mutual movement as determined by the waves. Different from the device according to the invention, it is not possible to find in this known device a component which is destined to be moved in and out of the water, to mention an important difference.

The said aspects, features and advantages of the invention are further explained on the basis of the figures, in which equal reference numerals indicate equal or similar components.

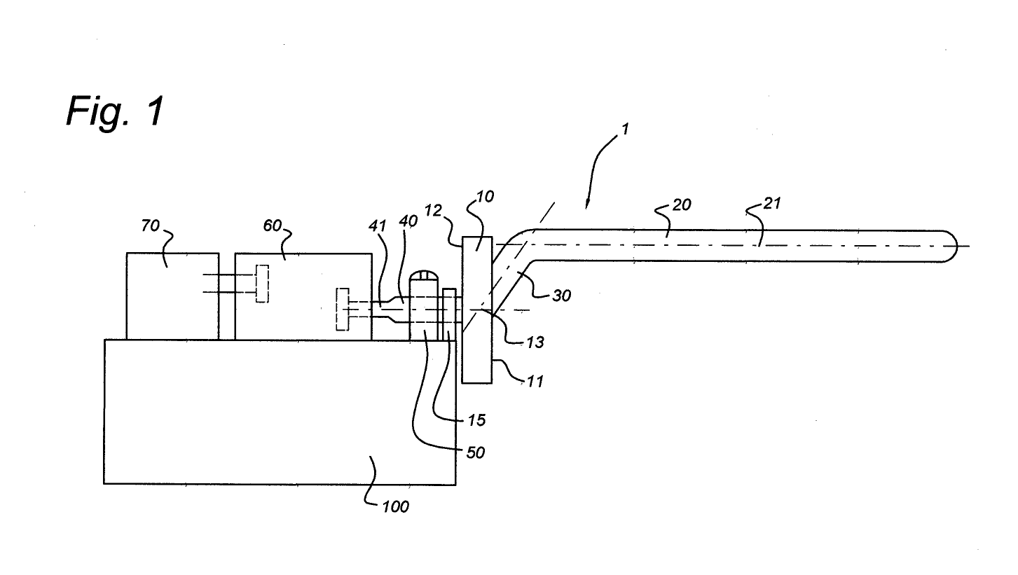

FIG. 1 diagrammatically shows a side view of the device according to the invention.

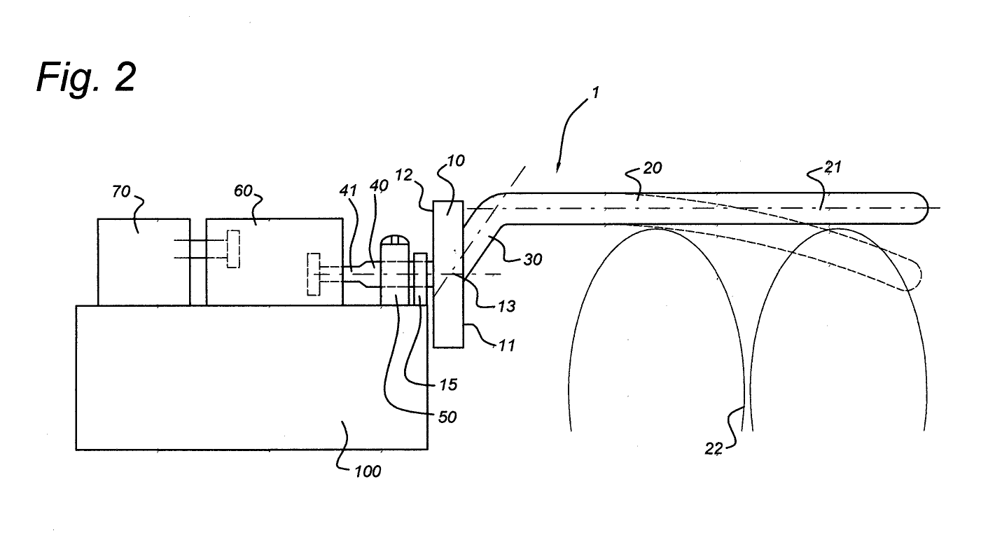

FIG. 2 also diagrammatically shows a side view of the device according to the invention, wherein a practical state of a rod-shaped body of the device and a direction of waves with respect to the rod-shaped body are indicated in the figure.

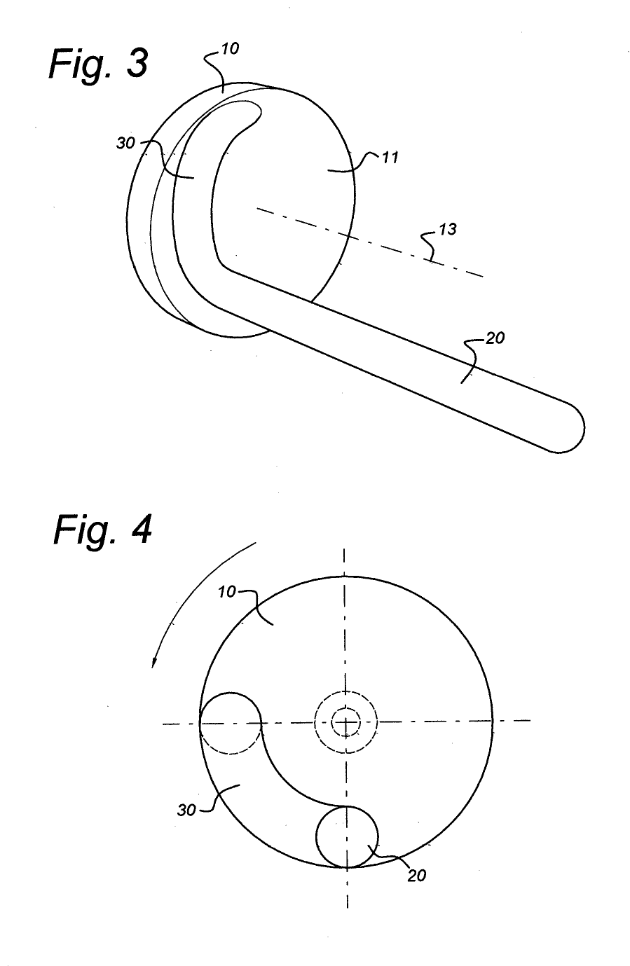

FIG. 3 diagrammatically shows a perspective view of an entirety of rod-shaped body, arm and basic body, which is part of the device according to the invention.

FIG. 4 diagrammatically shows a front view of the entirety of rod-shaped body, arm and basic body.

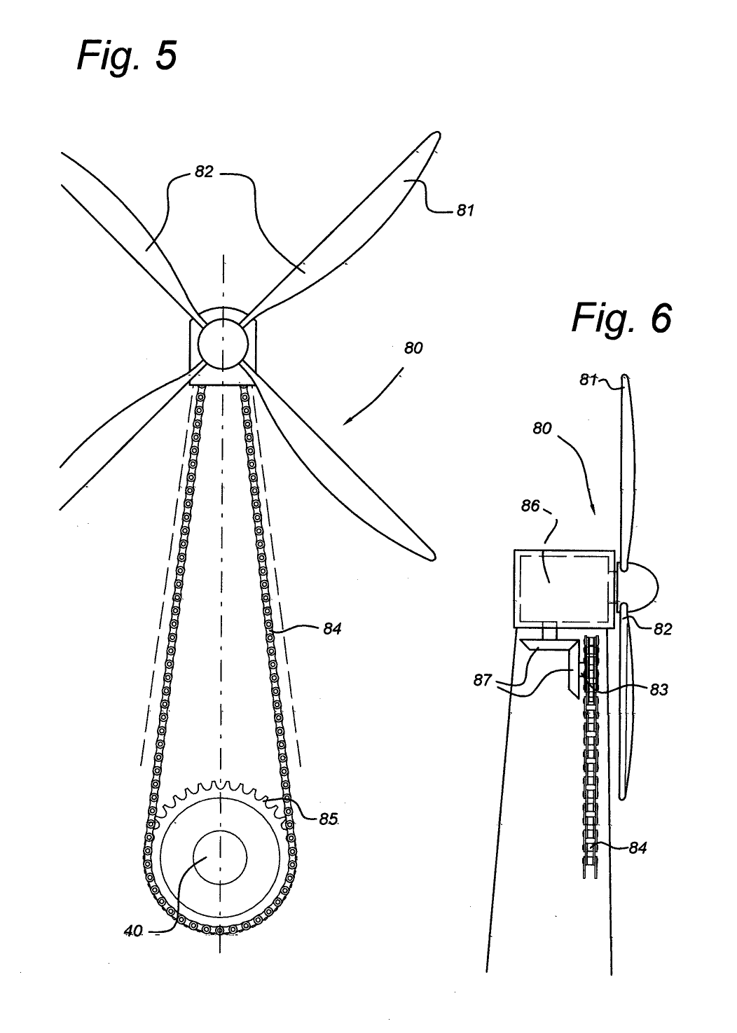

FIG. 5 diagrammatically shows a windmill which can be used with the device according to the invention, and components which couple an output shaft of the windmill to a main shaft of the device.

FIG. 6 illustrates an interior arrangement of the windmill.

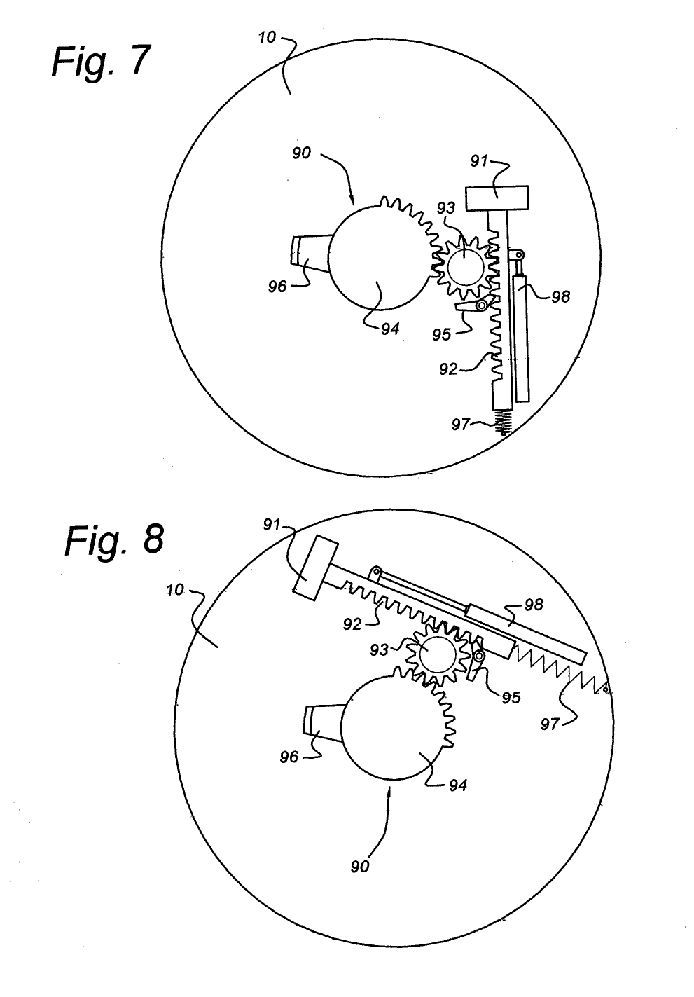

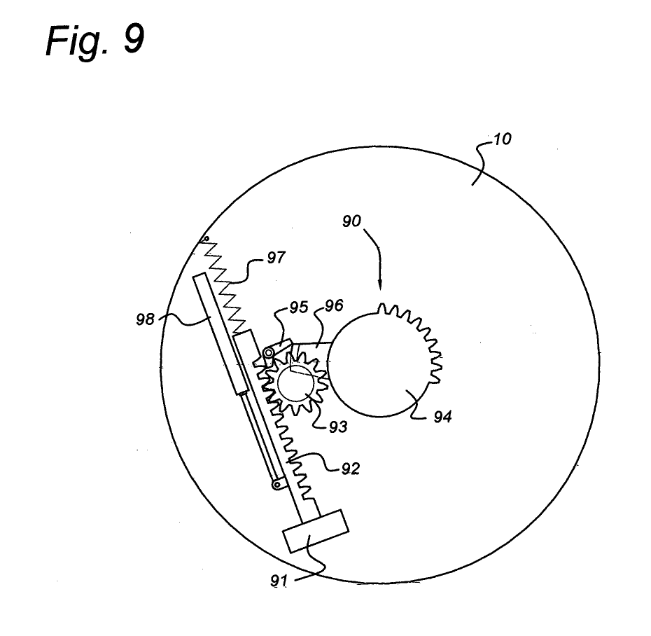

FIGS. 7-9 diagrammatically show components of a module which can be coupled to the basic body for supporting a rotary movement thereof, in three different states.

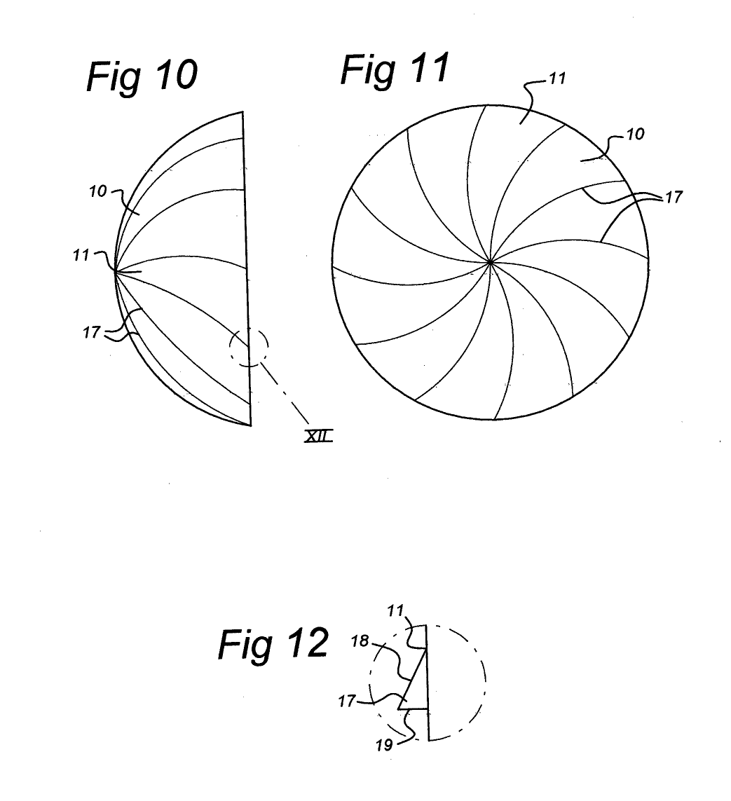

FIGS. 10 and 11 illustrate an option for design of the basic body.

FIG. 12 shows a detail of FIG. 10.

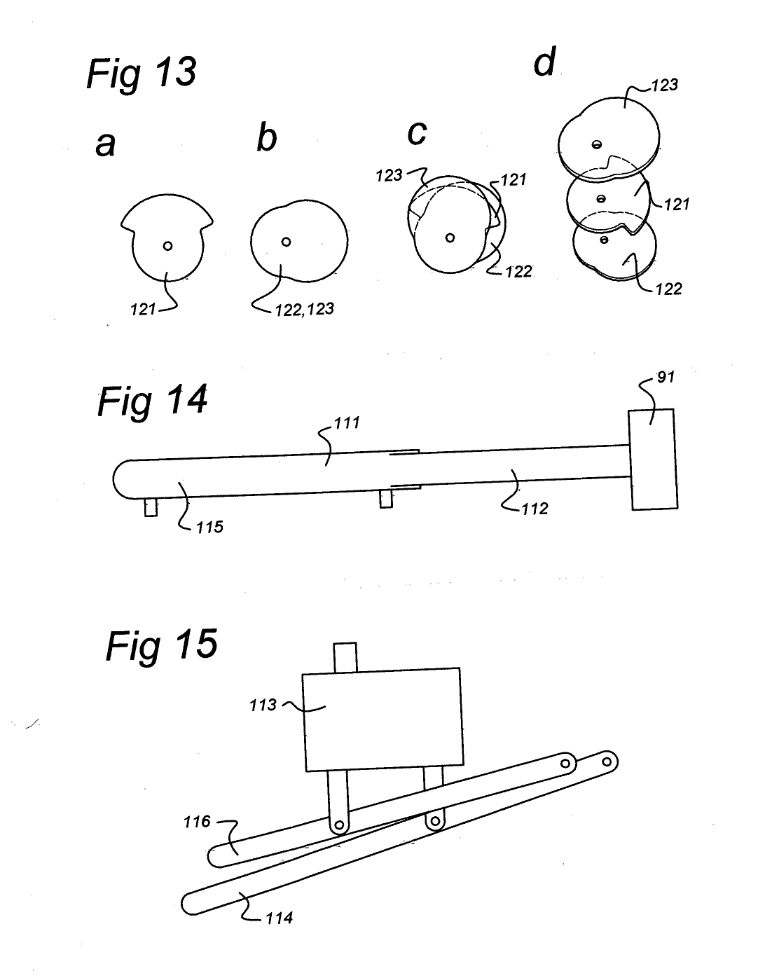

FIGS. 13-18 illustrate a hydraulic system and components of such system, which system serves for supporting a rotary movement of the basic body.

FIG. 1 provides an overall impression of the device 1 according to the invention, which is intended to generate energy on the basis of wave motion. For the purpose of a correct functioning of the device 1, the device 1 needs to be placed at sea, at the coast, as that is the environment in which wave motion is present. An advantageous season for applying the device 1 is a season in which many waves are present. In practice, a plurality of devices 1 can be applied with one another.

As can be seen in FIG. 1, the device 1 according to the invention comprises the following components: a basic body 10 which is rotatably arranged, and which is shaped like a cylinder in the shown example, an elongated, rod-shaped body 20 which is connected to a first end face 11 of the basic body 10, and which is destined to contact the water, an arm 30 which extends between the basic body 10 and the rod-shaped body 20 and thereby realises the connection between said bodies 10, 20, and a main shaft which is connected to a second end face 12 of the basic body 10. The main shaft 40 extends through a bearing 50 which is located on a basis 100 of the device 1. A rotation axis 41 of the main shaft 40 substantially coincides with a rotation axis 13 of the basic body 10. Therefore, when the basic body 10 is rotating, the main shaft 40 rotates directly along with the said body 10.

For the sake of clarity, a side of the basic body 10 where the rod-shaped body is located will hereinafter be referred to as front side. Consequently, the other side of the basic body 10, i.e. the side where the main shaft 40 is located, will hereinafter be referred to as back side. In an indication of relative places using the term “front” or “back”, this indication of the sides of the basic body 10 will be taken as a basic assumption.

At a position behind the bearing 50, a gear box 60 is located, which is arranged on the basis 100 as well. The main shaft 40 extends to inside the gear box 60, and is connected to one of the gears thereof. Behind the gear box 60, a generator 70 is located, which is connected to the gear box 60, which is arranged on the basis 100 as well, and which is adapted to transform mechanical energy into electrical energy. Bearings, gear boxes and generators are generally known, and therefore, the functioning of the bearing 50, the gear box 60 and the generator 70 of the device 1 according to the invention will not be further elucidated. The electrical energy which is output by the generator 70 can be transported from the position of the device 1 at sea to land in any suitable manner.

The rod-shaped body 20 can be made of any suitable material, wherein it is important that the said body 20 has buoyancy with respect to sea water. In the shown example, the rod-shaped body 20 has a straight longitudinal axis 21. However, in practice, the rod-shaped body 20 will sag on the basis of its own weight, as diagrammatically indicated by means of dashed lines in FIG. 2. This fact will be mentioned again and further elucidated later in this description. A suitable length of the rod-shaped body 20 is 7 meters, for example.

The arm 30 can form an integral entirety with the rod-shaped body 20. In the shown example, the arm 30 is connected to the end face 11 of the basic body 10 at the position of an outer peripheral area of the basic body 10. That does not alter the fact that within the framework of the invention, the arm 30 can be connected to the basic body 10 at any other position, wherein this position does not necessarily need to be a position on the said end face 11. Preferably, in determining a suitable position, the wish to let the device 1 have optimal output is taken into account. Furthermore, in the shown example, the arm 30 is shaped like a crank, more particularly as a quarter of a helix. In FIGS. 1-3, it is clearly shown that the arm 30 keeps the rod-shaped body 20 at a distance from the basic body 10. In FIG. 4, it is clearly shown that it is not only the attachment of the arm 30 on the basic body 10 which has an eccentric position with respect to the rotation axis 13 of the basic body 10. As seen from the front, as shown in FIG. 4, the arm 30 fixes the rod-shaped body 20 at a position which can also be denoted as being a position in the outer peripheral area of the basic body 10. The rod-shaped body 20 extends from that position to the front. Thus, the longitudinal axis 21 of the rod-shaped body 20 has an eccentric position with respect to the rotation axis 13 of the basic body 10. The functioning of the arm 30 will be elucidated later in this description.

In the device 1 according to the invention, a number of factors have an important function in the generation of energy as envisaged in the application of the device 1. In the first place, there is the interaction between the rod-shaped body 20 and the water. The rod-shaped body 20 is the component of the device 1 which can be put directly under the influence of waves. In the second place, there is the fact that the arm 30 has a special shape and keeps the rod-shaped body 20 at an eccentric position with respect to the basic body 10. As a result thereof, spring effects and effects of momentum action on the basic body 10 are obtained. In the third place, there is a functioning as flywheel of the basic body 10. Once the basic body 10 is rotating, it is capable of taking the rod-shaped body 20 along in a movement, regardless the further circumstances. Optionally, it is possible to use a windmill and/or an extra mass at the basic body 10, as will be indicated later in this description.

The device 1 according to the invention comprises an anti-rebound mechanism 15. For example, this can be arranged just behind the basic body 10, between the said body 10 and the bearing 50. In that case, such mechanism engages with the main shaft 40 and only allows for a rotation of the shaft in a single direction, while a rotation in opposite direction is blocked by the mechanism. Due to this, it is realised that the desired rotary movement in the device 1 can only take place in a single direction, always. If there are factors acting on the rod-shaped body 20 in such a way that an inclination to a movement in another direction occurs, such movement is prevented from actually happening. In that sense, an application of an anti-rebound mechanism 15 contributes to a secure functioning of the device 1 according to the invention, wherein disturbances of the process of energy generation are limited.

As has been remarked earlier, 7 meters is an example of a length of the rod-shaped body 10. An example of a diameter of the rod-shaped body 20 is about 0.4 meters. Furthermore, the basic body 10 can have a diameter of about 2.4 meters. In a choice of materials of the various components of the device 1 according to the invention, it is advantageous when various factors are taken into account, including wave force and water temperature. Naturally, materials which are resistant to the influence of sea water are typically to be considered. Material thickness and the mass of the basic body 10, among others, can be optimised for having a possibility of obtaining a high as possible efficiency of the energy generation.

In order to achieve an optimal functioning of the device 1 according to the invention, the device 1 is positioned such with respect to the water level in a vertical direction that the rod-shaped body 20 hangs in a highest position above the water, at least a portion at the attachment to the arm 30. In this position, and also in a movement to a lower position starting from this position, the rod-shaped body 20 sags under the influence of its own weight, as indicated by means of dashed lines in FIG. 2. Starting from the highest position, under the influence of gravity, the rod-shaped body 20 will always be inclined to assume a lower position.

For the purpose of starting the device 1 according to the invention, an additional motor (not shown) can be applied, which drives the main shaft 40, as a result of which the entirety of main shaft 40, basic body 10, arm 30 and rod-shaped body 20 is put in motion. Subsequently, the rotary movement can be continued by external factors, especially a pushing action of wave motion. When the highest position of the rod-shaped body 20 is taken as a starting point, a downward movement takes place first, under the influence of gravity and the kinetic energy in the basic body 10. During this movement, the rod-shaped body 20 strikes into the water, with an extra momentum originating from the arm 30. Due to the fact that the rod-shaped body 20 is bent, the body 20 strikes into the water more easily than when that would not be the case. Furthermore, due to this fact, there is extra contact with the water, especially oncoming waves. At that moment, the rod-shaped body 20 is pushed downwardly. However, the action of the waves 22 in the water, which are diagrammatically indicated in FIG. 2, is also important to the movement of the rod-shaped body 20 back in the upward direction again. Wave motion involves a pushing effect. On the basis thereof, the rod-shaped body 20 can be lifted again. The length of the rod-shaped body 20 is sufficient for obtaining this action of the wave motion. Also, the upward force of the water is a factor, as a result of which the rod-shaped body 20 inputs less weight, and in the meantime, the fact exists that kinetic energy is stored in the basic body 10. A part of this energy is used in the upward movement, as an addition to the energy from the waves 22 if necessary, and, in any case, to bring the rod-shaped body 20 all the way back to the highest position, when contact to the water gets less and less.

For the purpose of a practical application of the device 1 according to the invention, dimensions and other aspects of the device 1 can be optimised. For example, an important factor is an angle between the arm 30 and the end face 11 of the basic body 10.

For the sake of completeness, it is noted that in the shown example, as seen at the front, the arm 30 is twisted counter clockwise from the connection to the basic body 10 to the connection to the rod-shaped body 20. The correct rotary movement is also in that direction, as indicated in FIG. 4 by means of an arrow.

It can be desired to additionally support and/or stabilise the rotary movement in the device 1 according to the invention. A first option in that respect is the application of a windmill 80, as will be elucidated in the following with reference to FIGS. 5 and 6. As is known per se, a windmill 80 is provided with a rotor 81 having a number of rotor blades 82. Under the influence of wind, the rotor 81 is put in rotation. For a practical operation of the windmill 80, the windmill 80 is provided with means to rotate the rotor 81 to the actual direction of the wind in the correct manner.

In the shown example, an output shaft 83 of the windmill 80, i.e. a shaft 83 which is directly or indirectly connected to the rotor 81, is connected to the main shaft 40 by means of a chain 84, wherein a gear crown 85 to which the chain 84 engages is arranged on the main shaft 40. Within the framework of the invention, other transmission mechanisms are possible. The shown transmission mechanism having the chain 84 and the gear crown 85 can be designed to operate in a manner which is similar to that of a mechanism having a chain and gear crown as is usually present in a bicycle, wherein the wheels can rotate without the pedals necessarily needing to be operated. In analogy to this, additional momentum is only transmitted to the main shaft 40 when the rotor 81 rotates. As soon as this is not the case, the main shaft 40 simply rotates further without being hindered in this action.

In practice, the dimensions of the windmill 80 can be in an order of several meters. Furthermore, the windmill 80 can comprise an automatic gear box 86 which reduces the input speed and increases the input momentum, wherein the chain 84 is driven at the lower speed and the higher momentum, and which dampens and reduces possible shocks. In the shown example, an indirect coupling is present between the output shaft 83 and the rotor 81, namely a gear coupling 87 having gears which are arranged in a perpendicular fashion with respect to each other. Within the framework of the invention, alternative couplings are possible.

A second option for additionally supporting and/or stabilising the rotary movement of the device 1 according to the invention is the application of a module 90 having a mass 91 which is slidably arranged along the basic body 10, as shown in FIGS. 7-9. The mass 91 is arranged on a toothed bar 92, which is driven by means of a toothed gear 93 which is coupled to the basic body 10 and is thereby capable of following a rotary movement of the said body 10. The said toothed gear 93 engages another toothed gear 94 which has a stationary arrangement in the device 1, and which is provided with teeth along only a portion of the periphery. Furthermore, the module 90 comprises a locking embodied as a safety pin 95 which serves for preventing the toothed bar 92 from retracting after extending before a certain angular position of the basic body 10 is reached, a mechanical sensor 96 which is connected to the stationary toothed gear 94, and which is adapted to terminate the locking at a predetermined angular position of the basic body 10, a spring 97 which returns the toothed bar 92 to an initial position when the locking is terminated, and a damper 98 for preventing the toothed bar 92 from hitting hard at retraction.

In FIGS. 7-9, successive states of the module 90 are shown. The various components of the module 90, with the exception of the stationary toothed gear 94 and the mechanical sensor 96, rotate along with the basic body 10 over a portion of a complete rotation of the said body 10. Under the influence of the toothed gear 93 meshing with the stationary toothed gear 94, the toothed bar 92 extends, wherein the mass 91 is moved to a more outward position and is thereby capable of exerting a larger momentum. In that case, this momentum has a function in guaranteeing the rotary movement in the device 1 according to the invention. The module 90 can easily be adapted in such a way that the mass 91 is at the most outward position during a period of a complete rotation in which an extra momentum is the most desirable, i.e. a period in which the rod-shaped body 20 moves from a lower level to a higher level. In that case, before the lowest position of the rod-shaped body 20 is reached, the mass 91 exerts the largest momentum. When the locking is terminated, the module 90 assumes an initial position, wherein the mass 91 is moved to a more inward position again. The movement of the mass 91 is continually repeated per rotation, from inside to outside and back again, in order to vary the arm of the momentum in a favourable manner.

In a practical embodiment, for the purpose of supporting fixedly arranged components such as the mechanical sensor 96, a stationary shaft can be applied, which can be fixed in the gear box 60, for example, and which extends through the main shaft 40. Such shaft can be supported by bearings at one or more places.

Within the framework of the invention, other options for moving a mass 91 back and forth exist, as will be elucidated later in this description.

It will be clear to a person skilled in the art that the scope of the invention is not limited to the examples as discussed in the foregoing, but that various changes and modifications thereof are possible without deviating from the scope of the invention as defined in the attached claims.

Various aspects of the device 1 according to the invention can be further developed. By means of simulation and practical tests, it is possible to realise optimisation. For example, an ideal weight can be determined in respect of the basic body 10.

In comparison with known devices for generating energy on the basis of wave motion, the device 1 according to the invention has an uncomplicated structure. The device 1 can be built in an easy manner, does not require much maintenance and is environmentally friendly. In a simple manner, the bearing 50, the gear box 60 and the generator 70 can be prevented from contacting sea water, which facilitates lubrication of these components of the device 1 and prolongs the lifespan of these components, and which also prevents possible pollution of the water.

Within the scope of the invention, it is possible that the device 1 is provided with more than one rod-shaped body 20. In an application of two or more rod-shaped bodies 20, they can be mounted around the basic body, and can have various lengths.

In respect of the basic body 10, it is noted that it is advantageous when the first end face 11, i.e. the end face 11 to which the arm 30 and the rod-shaped body 20 are attached, has a convex shape. When the end face 11 would be planar, the waves 22 would continually encounter the basic body 10 fiercely as a result thereof, which can yield undesirable pressure on the device 1. By having a convex shape of the end face 11, that effect is reduced. Moreover, standing edges 17 can be arranged on the end face 11 in order to direct the waves 22 and to absorb energy from the waves 22 to a certain extent. For example, the standing edges 17 can be curved and extend from a central point to an outer periphery of the end face 11, so that delimited compartments are obtained for receiving the waves 22, which thereby contribute to a rotary movement of the basic body 10. The possible convex shape of the end face 11 of the basic body 10 is illustrated in FIG. 10. FIG. 11 shows a possible pattern of the edges 17 on the end face 11. FIG. 12 shows a detail of FIG. 10, in another view, and illustrates how the edges 17 can be embodied, namely with a ramp 18. Within the framework of the invention, other designs of the edges 17 are feasible, including designs in which a standing face 19 is concavely curved. For the sake of completeness, it is noted that an application of the edges 17 is optional, and that such application is possible with any shape of the end face 11. It is also noted that grooves can be applied in the end face 11 instead of standing edges 17, wherein it is also possible to have a combination of edges 17 and grooves.

As has been remarked earlier, it is possible to use a hydraulic system, for example, to move a mass 91 back and forth along the basic body 10. An example of such system 110, which includes a piston/cylinder device 111, and which can be controlled under the influence of the rotary movement of the basic body 10, wherein a piston 112 thereof functions as a lever, is illustrated in FIGS. 13-18.

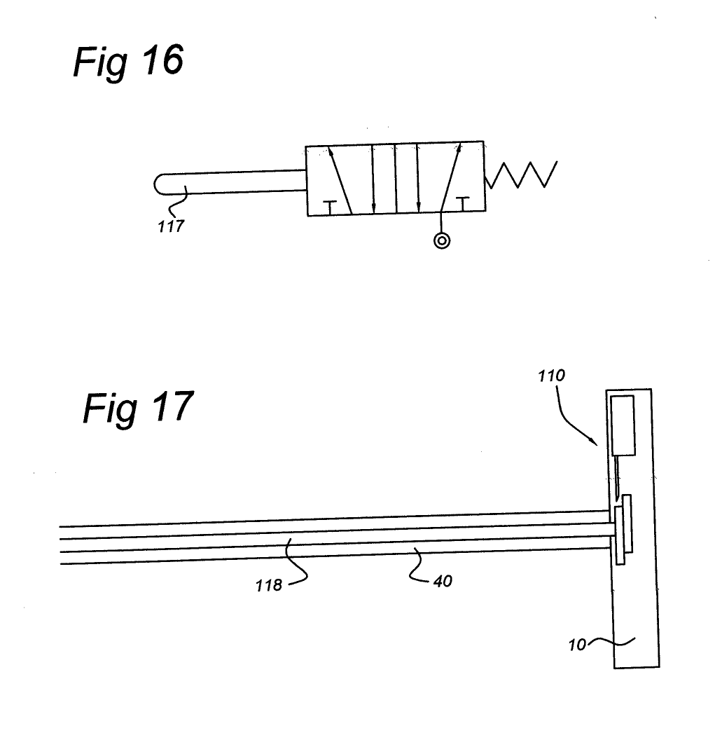

FIG. 13 diagrammatically shows a number of discs which serve as mechanical sensors in the system 110, as will be elucidated later in this description. FIG. 14 diagrammatically shows the piston/cylinder device 111 having the mass 91 at the end of the piston 112. FIG. 15 diagrammatically shows an oil reservoir 113 having a pump 114 for a suction portion of the cylinder 115 of the piston/cylinder device 111 and a pump 116 for a pressure portion of the cylinder 115. FIG. 16 diagrammatically shows a mechanical valve 117 for changing the flow from the suction side to the pressure side of the piston/cylinder device 111, or the other way around. FIG. 17 diagrammatically shows a fixed shaft 118 which extends through the main shaft 40, and which serves for supporting fixedly arranged components of the hydraulic system 110, in particular the aforementioned discs. With reference to FIG. 13, it is noted that a first disc 121 serves for controlling the valve 117, a second disc 122 serves for displacing a hydraulic handle of the pump 114 for the suction portion of the cylinder 115, and that a third disc 123 serves for displacing a hydraulic handle of the pump 116 for the pressure portion of the cylinder 115.

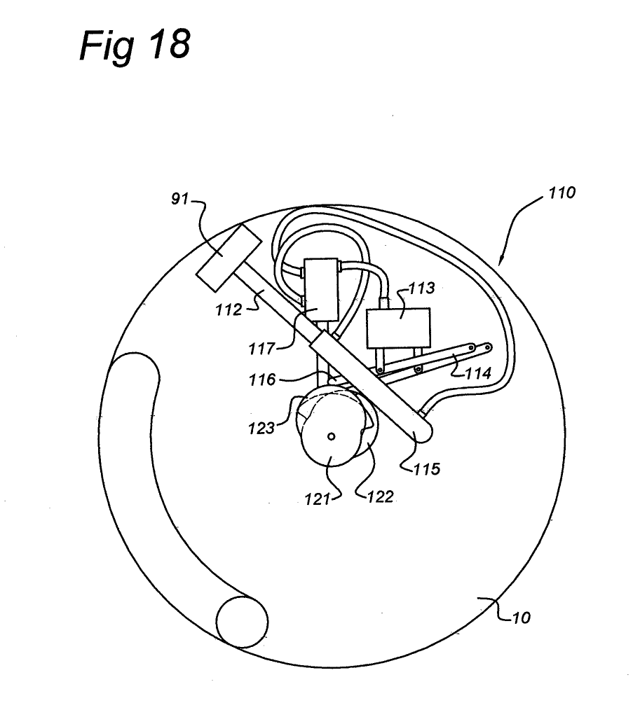

In FIG. 18, an interrelation of various components of the hydraulic system 110 is illustrated. An important function of the system 110 is promoting the monotony of a rotary speed of the basic body 10. At a certain moment, it can be desired to have an extra rotation momentum. This can be realised by using a lever, which is embodied by the piston 112 of the piston/cylinder device 111 in the shown example. At a critical moment during the rotary movement of the basic body 10, the piston 112 is extended to a maximum, so that the largest force can be exerted on the basic body 10. In that way, the basic body 10 can pass a critical point in the rotary movement.

In particular, the hydraulic system 110 functions as follows. During the rotary movement of the basic body 10, the hydraulic handle of the pump 116 for the pressure portion of the cylinder 115 is pushed in an upward direction, so that the oil reservoir 113 pumps the oil to the cylinder 115, particularly to the pressure side thereof, through the valve 117. As the hydraulic handle moves further upward, the cylinder 115 extends further. After passing a highest point of the third disc 123, the hydraulic handle gradually moves down again. At a certain moment, the hydraulic handle of the pump 114 for the suction portion of the cylinder 115 is pushed gradually upward. As a consequence, the first disc 121 takes care of activation of the valve 117. At that moment, the direction of the oil flow starts to change from pressure portion to suction portion of the piston/cylinder device 111, and the piston 112 gradually returns to a more retracted position. In this position, in order to have proper functioning, it is important that the piston 112 has a counter position of its weight in the basic body 10.

The invention can be summarised as follows. A device 1 for generating energy on the basis of wave motion comprises a rotatably arranged basic body 10; an elongated, rod-shaped body 20 which is connected to the basic body 10, and which has buoyancy with respect to sea water; an arm 30 which extends between the basic body 10 and the rod-shaped body 20 and interconnects these two bodies 10, 20; and a main shaft 40 which is connected to the basic body 10 for the purpose of being driven by the basic body 10. Optionally, a rotation axis 41 of the main shaft 40 substantially coincides with a rotation axis 13 of the basic body 10. Furthermore, the device 1 can be provided with means 15 to allow for rotation of the basic body 10 in one direction and block such rotation in the other direction. The rod-shaped body 20 is destined to be moved in and out of the water under the influence of wave motion, and of a rotary movement of the basic body 10, which performs a flywheel function during operation of the device 1. Due to this, the said rotary movement, which constitutes the basis of the generation of energy, can be maintained.

1. Device (1) for generating energy on the basis of wave motion, comprising:
a rotatably arranged basic body (10);
an elongated, rod-shaped body (20) which is connected to the basic body (10), which has buoyancy with respect to sea water, and which is destined to be moved in and out of the water under the influence of wave motion, and of a rotary movement of the basic body (10);
an arm (30) which extends between the basic body (10) and the rod-shaped body (20), and which connects these two bodies (10, 20) with each other; and
a main shaft (40) which is connected to the basic body (10) in order to be driven by the basic body (10).

2. Device (1) according to claim 1, wherein the rod-shaped body (20) extends at a position which, as projected on the basic body (10) in the direction of a rotation axis (13) of the basic body (10), is eccentric with respect to the rotation axis (13) of the basic body (10).

3. Device (1) according to claim 1 or 2, wherein the arm (30) is connected to the basic body (10) at a position which is eccentric with respect to a rotation axis (13) of the basic body (10), wherein the arm (30) is connected to the rod-shaped body (20) at a position which is at a distance from the basic body (10).

4. Device (1) according to any of claims 1-3, wherein the rod-shaped body (20) and the main shaft (40) extend at different sides of the basic body (10).

5. Device according to any of claims 1-4, wherein the basic body (10) is shaped like a cylinder, wherein the rod-shaped body (20) is connected to a first end face (11) of the basic body (10), and wherein the main shaft (40) is connected to a second end face (12) of the basic body 10.

6. Device (1) according to any of claims 1-5, further comprising means (15) to allow for rotation of the basic body (10) in one direction and to block such rotation in the other direction.

7. Device (1) according to any of claims 1-6, wherein a rotation axis (41) of the main shaft (40) substantially coincides with a rotation axis (13) of the basic body (10).

8. Device (1) according to any of claims 1-7, wherein the rod-shaped body (20) and the arm (30) are formed as one integral entirety.

9. Device (1) according to any of claims 1-8, further comprising a gear box (60), wherein the main shaft (40) is connected to one of the gears of the gear box (60).

10. Device (1) according to claim 9, further comprising means (50) for bearing the main shaft (40) on at least one position between the basic body (10) and the gear box (60).

11. Device (1) according to any of claims 1-10, further comprising a motor for driving the main shaft (40).

12. Device (1) according to any of claims 1-11, further comprising a generator (70) for transforming mechanical energy into electrical energy.

13. Device (1) according to any of claims 1-12, further comprising a windmill (80) and means (84, 85) for translating a rotation of an output shaft (83) of the windmill (80) to the main shaft (40).

14. Device (1) according to any of claims 1-13, further comprising a module (90) having a mass (91) which is slidably arranged along the basic body (10), and means for driving the mass (91).

15. Device (1) according to claim 14, wherein the means for driving the mass (91) comprise a toothed bar (92) and a toothed gear (93) for translating the toothed bar (92), wherein a coupling between the toothed gear (93) and the basic body (10) is provided, and wherein the mass (91) is located on the toothed bar (92).

16. Device (1) according to claim 15, wherein the means for driving the mass (91) comprise a hydraulic system (110) having a piston/cylinder device (111).

17. Device (1) according to any of claims 1-16, wherein an end face (11) of the basic body (10) to which the arm (30) and the rod-shaped body (20) are attached has a convex shape.

18. Device (1) according to any of claims 1-17, wherein a pattern of standing edges (17) is located on the end face (11).

19. Device (1) according to any of claims 1-18, wherein the end face (11) is provided with a pattern of grooves.

20. Device (1) according to any of claims 1-19, arranged close to a coast, wherein a longitudinal axis of the rod-shaped body is oriented substantially perpendicular with respect to the coastline.
